(19) United States
(12) Patent Application Publication
(10) Pub. No.: US 2018/0109429 A1
(43) Pub. Date: Apr. 19, 2018

(54) INTUITIVE APPROACH TO VISUALIZE HEALTH OF MICROSERVICE POLICIES

(71) Applicant: Cisco Technology, Inc., San Jose, CA (US)

(72) Inventors: Ruchir Gupta, Fremont, CA (US); Sanjay Agrawal, San Jose, CA (US); Yi Yang, San Jose, CA (US); Wojciech Dec, San Jose, CA (US); Syed Basheeruddin Ahmed, San Jose, CA (US)

(21) Appl. No.: 15/298,102

(22) Filed: Oct. 19, 2016

(51) Int. Cl. H04L 12/24; G06T 11/20; G06T 11/00; G06F 3/0481

(52) U.S. Cl. CPC H04L 41/22; G06T 11/206; H04L 41/5032; G06F 3/0481; G06T 11/001

(57) ABSTRACT

A controller in a network can gather operational data describing performance of an end point group in the network. The end point group can include one or more containers providing microservices. The controller can calculate an overall health score for the end point group based on the operational data. The overall health score can indicate whether an actual overall performance of the end point group is meeting a desired overall performance of the end point group defined by a first set of policies assigned to the end point group. The controller can present, in a graphical user interface, a visual representation of the overall health score. The visual representation of the overall health score can indicate that the overall health score is within a first overall health range from a set of two or more overall health ranges.

### TECHNICAL FIELD

This disclosure relates in general to the field of computer networks and, more particularly, pertains to an intuitive approach to visualize health of microservice policies.

### BACKGROUND

Container based micro services is an architecture that is quickly being adopted in the Data Center/Cloud Industry. Rather than build a single large, monolithic application, container based micro services split the application into a set of smaller interconnected services. Managing network resources can be challenging in large scale microservice environments. Group Based Policy (GBP) aims to address cloud complexity by offering a simple abstract Application Programming Interface (API), designed to capture user intent. In GBP, a contract describes the relationship between End Point Groups (EPGs). GBP works well with a container based microservice architecture. For example, EPGs can represent each microservice and contracts can represent APIs. When deploying GBP in a microservice architecture, it is important to verify that policies have been resolved and implemented correctly, and to monitor the ongoing policy execution health. Doing so, however, is difficult and poses challenges. Accordingly, improvements are needed.

### BRIEF DESCRIPTION OF THE DRAWINGS

In order to describe the manner in which the above-recited features and other advantages of the disclosure can be obtained, a more particular description of the principles briefly described above will be rendered by reference to specific embodiments thereof which are illustrated in the appended drawings. Understanding that these drawings depict only exemplary embodiments of the disclosure and are not therefore to be considered to be limiting its scope, the principles herein are described and explained with additional specificity and detail through the use of the accompanying drawings in which:

FIG. 1 illustrates an example network device according to some aspects of the subject technology;

FIGS. 2A and 2B illustrate an example system embodiments according to some aspects of the subject technology;

FIG. 3 illustrates a schematic block diagram of an example architecture for a network fabric;

FIG. 4 illustrates an example overlay network;

FIG. 5 illustrates an example controller for visualizing health of microservice policies;

FIG. 6 illustrates an example of a user interface for visualizing health of microservice policies;

FIG. 7 illustrates another example of a user interface for visualizing health of microservice policies; and

FIG. 8 illustrates an example method of visualizing health of microservice policies.

### DESCRIPTION OF EXAMPLE EMBODIMENTS

The detailed description set forth below is intended as a description of various configurations of the subject technology and is not intended to represent the only configurations in which the subject technology can be practiced. The appended drawings are incorporated herein and constitute a part of the detailed description. The detailed description includes specific details for the purpose of providing a more thorough understanding of the subject technology. However, it will be clear and apparent that the subject technology is not limited to the specific details set forth herein and may be practiced without these details. In some instances, structures and components are shown in block diagram form in order to avoid obscuring the concepts of the subject technology.

### Overview:

Disclosed are systems, methods, and computer-readable storage media for an intuitive approach to visualize health of microservice policies. A controller in a network can gather operational data describing performance of an end point group in the network. The end point group can include one or more containers providing microservices. The controller can calculate an overall health score for the end point group based on the operational data. The overall health score can indicate whether an actual overall performance of the end point group is meeting a desired overall performance of the end point group defined by a first set of policies assigned to the end point group. The controller can present a visual representation of the overall health score in a graphical user interface. The visual representation of the overall health score can indicate that the overall health score is within a first overall health range from a set of two or more overall health ranges.

### Example Embodiments

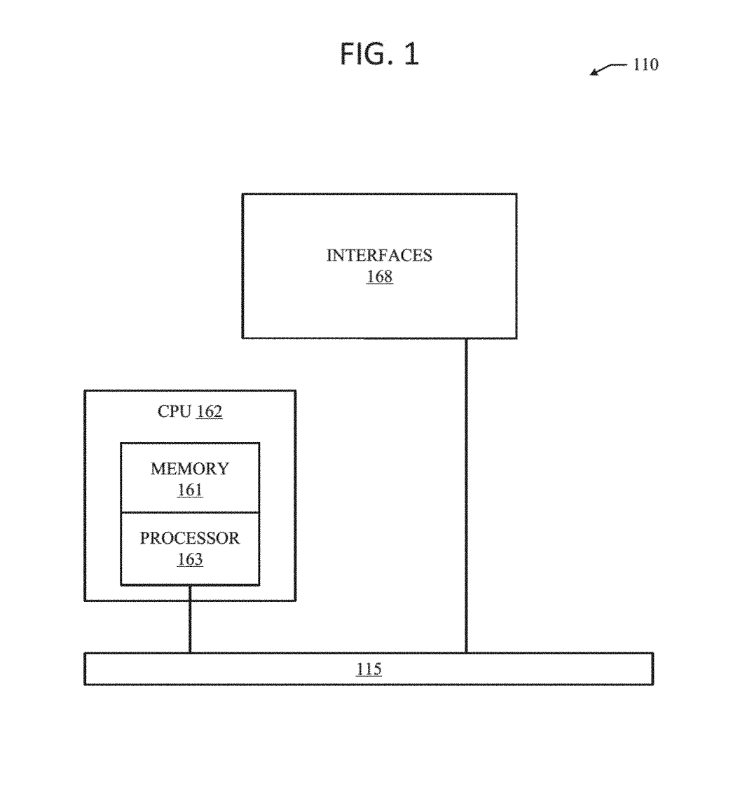

Disclosed are systems and methods for an intuitive approach to visualize health of microservice policies. A brief introductory description of exemplary systems and networks, as illustrated in FIGS. 1 through 4, is disclosed herein, followed by a discussion of an intuitive approach to visualize health of microservice policies. The disclosure now turns to FIG. 1.

A computer network is a geographically distributed collection of nodes interconnected by communication links and segments for transporting data between end points, such as personal computers and workstations. Many types of networks are available, with the types ranging from local area networks (LANs) and wide area networks (WANs) to overlay and software-defined networks, such as virtual extensible local area networks (VXLANs).

LANs typically connect nodes over dedicated private communications links located in the same general physical location, such as a building or campus. WANs, on the other hand, typically connect geographically dispersed nodes over long-distance communications links, such as common carrier telephone lines, optical lightpaths, synchronous optical networks (SONET), or synchronous digital hierarchy (SDH) links. LANs and WANs can include layer 2 (L2) and/or layer 3 (L3) networks and devices.

The Internet is an example of a WAN that connects disparate networks throughout the world, providing global communication between nodes on various networks. The nodes typically communicate over the network by exchanging discrete frames or packets of data according to predefined protocols, such as the Transmission Control Protocol/Internet Protocol (TCP/IP). In this context, a protocol can refer to a set of rules defining how the nodes interact with each other. Computer networks may be further interconnected by an intermediate network node, such as a router, to extend the effective “size” of each network.

Overlay networks generally allow virtual networks to be created and layered over a physical network infrastructure. Overlay network protocols, such as Virtual Extensible LAN (VXLAN), Network Virtualization using Generic Routing Encapsulation (NVGRE), Network Virtualization Overlays (NVO3), and Stateless Transport Tunneling (STT), provide a traffic encapsulation scheme which allows network traffic to be carried across L2 and L3 networks over a logical tunnel. Such logical tunnels can be originated and terminated through virtual tunnel end points (VTEPs).

Moreover, overlay networks can include virtual segments, such as VXLAN segments in a VXLAN overlay network, which can include virtual L2 and/or L3 overlay networks over which virtual machines (VMs) and microservice containers communicate. The virtual segments can be identified through a virtual network identifier (VNI), such as a VXLAN network identifier, which can specifically identify an associated virtual segment or domain.

Network virtualization allows hardware and software resources to be combined in a virtual network. For example, network virtualization can allow multiple numbers of VMs and microservice containers to be attached to the physical network via respective virtual LANs (VLANs). The VMs and microservice containers can be grouped according to their respective VLAN, and can communicate with other VMs and microservice containers as well as other devices on the internal or external network.

Network segments, such as physical or virtual segments; networks; devices; ports; physical or logical links; and/or traffic in general can be grouped into a bridge or flood domain. A bridge domain or flood domain can represent a broadcast domain, such as an L2 broadcast domain. A bridge domain or flood domain can include a single subnet, but can also include multiple subnets. Moreover, a bridge domain can be associated with a bridge domain interface on a network device, such as a switch. A bridge domain interface can be a logical interface which supports traffic between an L2 bridged network and an L3 routed network. In addition, a bridge domain interface can support internet protocol (IP) termination, VPN termination, address resolution handling, MAC addressing, etc. Both bridge domains and bridge domain interfaces can be identified by a same index or identifier.

Furthermore, end point groups (EPGs) can be used in a network for mapping applications to the network. In particular, EPGs can use a grouping of similar application end points (e.g., microservice containers) in a network to apply connectivity and policy to the group. EPGs can act as a container for buckets or collections of microservice containers, applications, or application components, and tiers for implementing forwarding and policy logic. EPGs also allow separation of network policy, security, and forwarding from addressing and network segmentation (vlans or vxlans) by instead using logical application boundaries.

Cloud computing can also be provided in one or more networks to provide computing services using shared resources. Cloud computing can generally include Internet-based computing in which computing resources are dynamically provisioned and allocated to client or user computers or other devices on-demand, from a collection of resources available via the network (e.g., “the cloud”). Cloud computing resources, for example, can include any type of resource, such as computing, storage, and network devices, virtual machines (VMs), microservice containers, etc. For instance, resources may include service devices (firewalls, deep packet inspectors, traffic monitors, load balancers, etc.), compute/processing devices (servers, CPU's, memory, brute force processing capability), storage devices (e.g., network attached storages, storage area network devices), etc. In addition, such resources may be used to support virtual networks, virtual machines (VM), microservice containers, databases, applications (Apps), etc.

Cloud computing resources may include a “private cloud,” a “public cloud,” and/or a “hybrid cloud.” A “hybrid cloud” can be a cloud infrastructure composed of two or more clouds that inter-operate or federate through technology. In essence, a hybrid cloud is an interaction between private and public clouds where a private cloud joins a public cloud and utilizes public cloud resources in a secure and scalable manner. Cloud computing resources can also be provisioned via virtual networks in an overlay network, such as a VXLAN.

FIG. 1 illustrates an exemplary network device 110 suitable for implementing the present technology. Network device 110 includes a master central processing unit (CPU) 162, interfaces 168, and a bus 115 (e.g., a PCI bus). When acting under the control of appropriate software or firmware, the CPU 162 is responsible for executing packet management, error detection, and/or routing functions, such policy enforcement, for example. The CPU 162 preferably accomplishes all these functions under the control of software including an operating system and any appropriate applications software. CPU 162 may include one or more processors 163 such as a processor from the Motorola family of microprocessors or the MIPS family of microprocessors. In an alternative embodiment, processor 163 is specially designed hardware for controlling the operations of network device 110. In a specific embodiment, a memory 161 (such as non-volatile RAM and/or ROM) also forms part of CPU 162. However, there are many different ways in which memory could be coupled to the system.

The interfaces 168 are typically provided as interface cards (sometimes referred to as “line cards”). Generally, they control the sending and receiving of data packets over the network and sometimes support other peripherals used with the network device 110. Among the interfaces that may be provided are Ethernet interfaces, frame relay interfaces, cable interfaces, DSL interfaces, token ring interfaces, and the like. In addition, various very high-speed interfaces may be provided such as fast token ring interfaces, wireless interfaces, Ethernet interfaces, Gigabit Ethernet interfaces, ATM interfaces, HSSI interfaces, POS interfaces, FDDI interfaces and the like. Generally, these interfaces may include ports appropriate for communication with the appropriate media. In some cases, they may also include an independent processor and, in some instances, volatile RAM. The independent processors may control such communications intensive tasks as packet switching, media control, and management. By providing separate processors for the communications intensive tasks, these interfaces allow the master microprocessor 162 to efficiently perform control plane functions, such as routing computations, network diagnostics, security functions, etc.

Although the system shown in FIG. 1 is one specific network device of the present technology, it is by no means the only network device architecture on which the present technology can be implemented. For example, an architecture having a single processor that handles communications as well as routing computations, etc. is often used. Further, other types of interfaces and media could also be used with the network device.

Regardless of the network device's configuration, it may employ one or more memories or memory modules (including memory 161) configured to store program instructions for the general-purpose network operations and mechanisms for roaming, route optimization and routing functions described herein. The program instructions may control the operation of an operating system and/or one or more applications, for example. The memory or memories may also be configured to store tables such as mobility binding, registration, and association tables, etc.

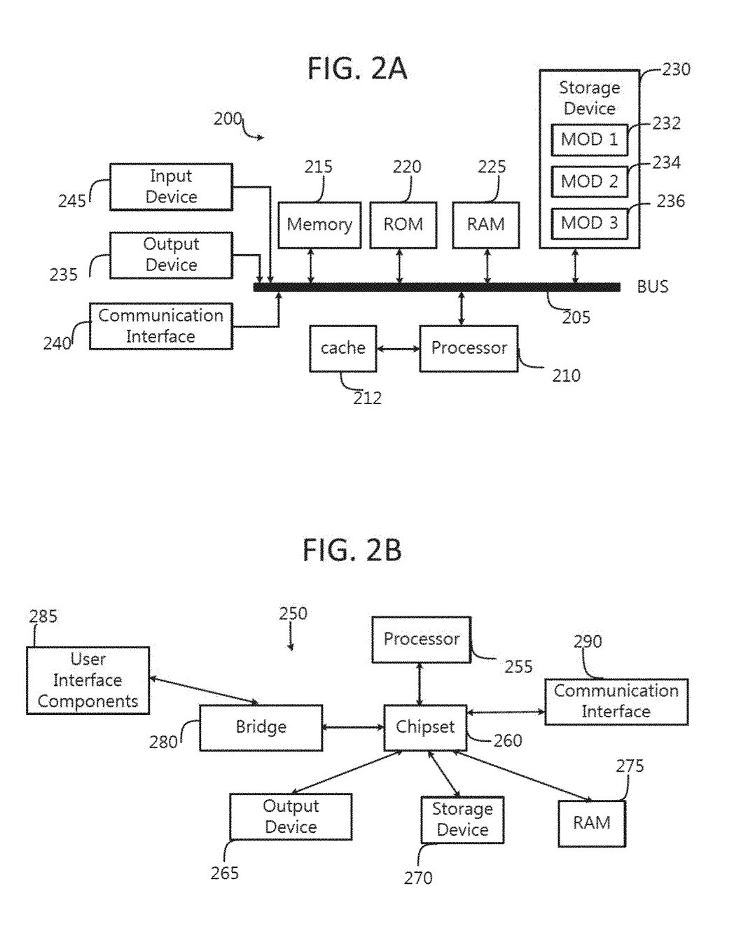

FIG. 2A, and FIG. 2B illustrate exemplary possible system embodiments. The more appropriate embodiment will be apparent to those of ordinary skill in the art when practicing the present technology. Persons of ordinary skill in the art will also readily appreciate that other system embodiments are possible.

FIG. 2A illustrates a conventional system bus computing system architecture 200 wherein the components of the system are in electrical communication with each other using a bus 205. Exemplary system 200 includes a processing unit (CPU or processor) 210 and a system bus 205 that couples various system components including the system memory 215, such as read only memory (ROM) 220 and random access memory (RAM) 225, to the processor 210. The system 200 can include a cache of high-speed memory connected directly with, in close proximity to, or integrated as part of the processor 210. The system 200 can copy data from the memory 215 and/or the storage device 230 to the cache 212 for quick access by the processor 210. In this way, the cache can provide a performance boost that avoids processor 210 delays while waiting for data. These and other modules can control or be configured to control the processor 210 to perform various actions. Other system memory 215 may be available for use as well. The memory 215 can include multiple different types of memory with different performance characteristics. The processor 210 can include any general purpose processor and a hardware module or software module, such as module 1 232, module 2 234, and module 3 236 stored in storage device 230, configured to control the processor 210 as well as a special-purpose processor where software instructions are incorporated into the actual processor design. The processor 210 may essentially be a completely self-contained computing system, containing multiple cores or processors, a bus, memory controller, cache, etc. A multi-core processor may be symmetric or asymmetric.

To enable user interaction with the computing device 200, an input device 245 can represent any number of input mechanisms, such as a microphone for speech, a touch-sensitive screen for gesture or graphical input, keyboard, mouse, motion input, speech and so forth. An output device 235 can also be one or more of a number of output mechanisms known to those of skill in the art. In some instances, multimodal systems can enable a user to provide multiple types of input to communicate with the computing device 200. The communications interface 240 can generally govern and manage the user input and system output. There is no restriction on operating on any particular hardware arrangement and therefore the basic features here may easily be substituted for improved hardware or firmware arrangements as they are developed.

Storage device 230 is a non-volatile memory and can be a hard disk or other types of computer readable media which can store data that are accessible by a computer, such as magnetic cassettes, flash memory cards, solid state memory devices, digital versatile disks, cartridges, random access memories (RAMs) 225, read only memory (ROM) 220, and hybrids thereof.

The storage device 230 can include software modules 232, 234, 236 for controlling the processor 210. Other hardware or software modules are contemplated. The storage device 230 can be connected to the system bus 205. In one aspect, a hardware module that performs a particular function can include the software component stored in a computer-readable medium in connection with the necessary hardware components, such as the processor 210, bus 205, output device 235, and so forth, to carry out the function.

FIG. 2B illustrates a computer system 250 having a chipset architecture that can be used in executing the described method and generating and displaying a graphical user interface (GUI). Computer system 250 is an example of computer hardware, software, and firmware that can be used to implement the disclosed technology. System 250 can include a processor 255, representative of any number of physically and/or logically distinct resources capable of executing software, firmware, and hardware configured to perform identified computations. Processor 255 can communicate with a chipset 260 that can control input to and output from processor 255. In this example, chipset 260 outputs information to output 265, such as a display, and can read and write information to storage device 270, which can include magnetic media, and solid state media, for example. Chipset 260 can also read data from and write data to RAM 275. A bridge 280 for interfacing with a variety of user interface components 285 can be provided for interfacing with chipset 260. Such user interface components 285 can include a keyboard, a microphone, touch detection and processing circuitry, a pointing device, such as a mouse, and so on. In general, inputs to system 250 can come from any of a variety of sources, machine generated and/or human generated.

Chipset 260 can also interface with one or more communication interfaces 290 that can have different physical interfaces. Such communication interfaces can include interfaces for wired and wireless local area networks, for broadband wireless networks, as well as personal area networks. Some applications of the methods for generating, displaying, and using the GUI disclosed herein can include receiving ordered datasets over the physical interface or be generated by the machine itself by processor 255 analyzing data stored in storage 270 or RAM 275. Further, the machine can receive inputs from a user via user interface components 285 and execute appropriate functions, such as browsing functions by interpreting these inputs using processor 255.

It can be appreciated that exemplary systems 200 and 250 can have more than one processor 210 or be part of a group or cluster of computing devices networked together to provide greater processing capability.

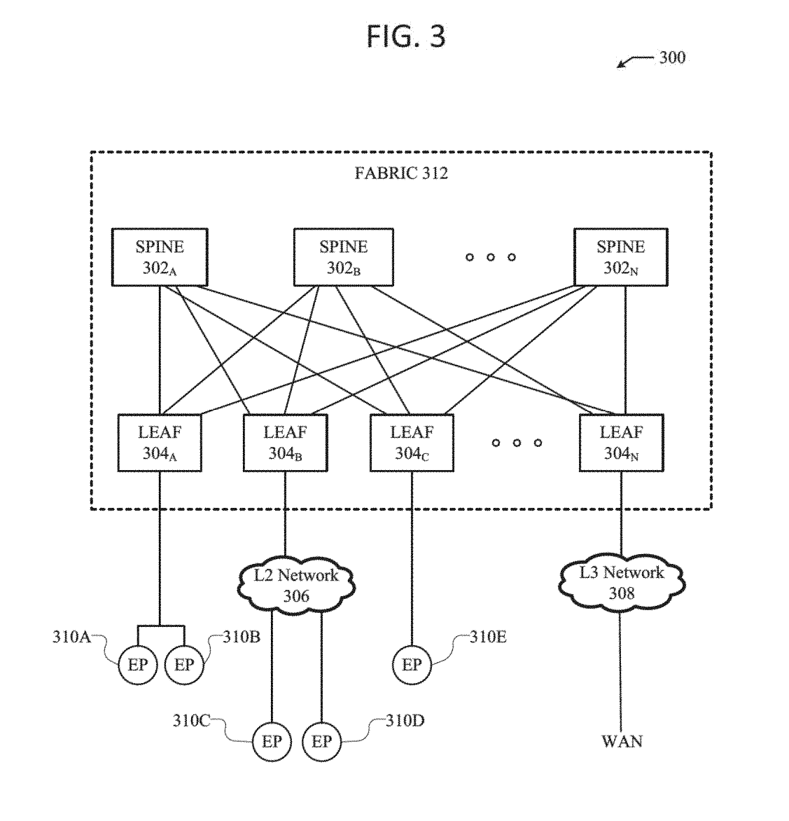

FIG. 3 illustrates a schematic block diagram of an example architecture 300 for a network fabric 312. The network fabric 312 can include spine switches 302_{A}, 302_{B}, . . . , 302_{N} (collectively “302”) connected to leaf switches 304_{A}, 304_{B}, 304_{C} . . . 304_{N} (collectively “304”) in the network fabric 312.

Spine switches 302 can be L3 switches in the fabric 312. However, in some cases, the spine switches 302 can also, or otherwise, perform L2 functionalities. Further, the spine switches 302 can support various capabilities, such as 40 or 10 Gbps Ethernet speeds. To this end, the spine switches 302 can include one or more 40 Gigabit Ethernet ports. Each port can also be split to support other speeds. For example, a 40 Gigabit Ethernet port can be split into four 10 Gigabit Ethernet ports.

In some embodiments, one or more of the spine switches 302 can be configured to host a proxy function that performs a lookup of the end point address identifier to locator mapping in a mapping database on behalf of leaf switches 304 that do not have such mapping. The proxy function can do this by parsing through the packet to the encapsulated tenant packet to get to the destination locator address of the tenant. The spine switches 302 can then perform a lookup of their local mapping database to determine the correct locator address of the packet and forward the packet to the locator address without changing certain fields in the header of the packet.

When a packet is received at a spine switch 302ᵢ, the spine switch 302ᵢ can first check if the destination locator address is a proxy address. If so, the spine switch 302ᵢ can perform the proxy function as previously mentioned. If not, the spine switch 302ᵢ can look up the locator in its forwarding table and forward the packet accordingly.

Spine switches 302 connect to leaf switches 304 in the fabric 312. Leaf switches 304 can include access ports (or non-fabric ports) and fabric ports. Fabric ports can provide uplinks to the spine switches 302, while access ports can provide connectivity for devices, hosts, end points, VMs, microservice containers, or external networks to the fabric 312.

Leaf switches 304 can reside at the edge of the fabric 312, and can thus represent the physical network edge. In some cases, the leaf switches 304 can be top-of-rack (“ToR”) switches configured according to a ToR architecture. In other cases, the leaf switches 304 can be aggregation switches in any particular topology, such as end-of-row (EoR) or middle-of-row (MoR) topologies. The leaf switches 304 can also represent aggregation switches, for example.

The leaf switches 304 can be responsible for routing and/or bridging the data packets and applying network policies. In some cases, a leaf switch can perform one or more additional functions, such as implementing a mapping cache, sending packets to the proxy function when there is a miss in the cache, encapsulating packets, enforcing ingress or egress policies, etc.

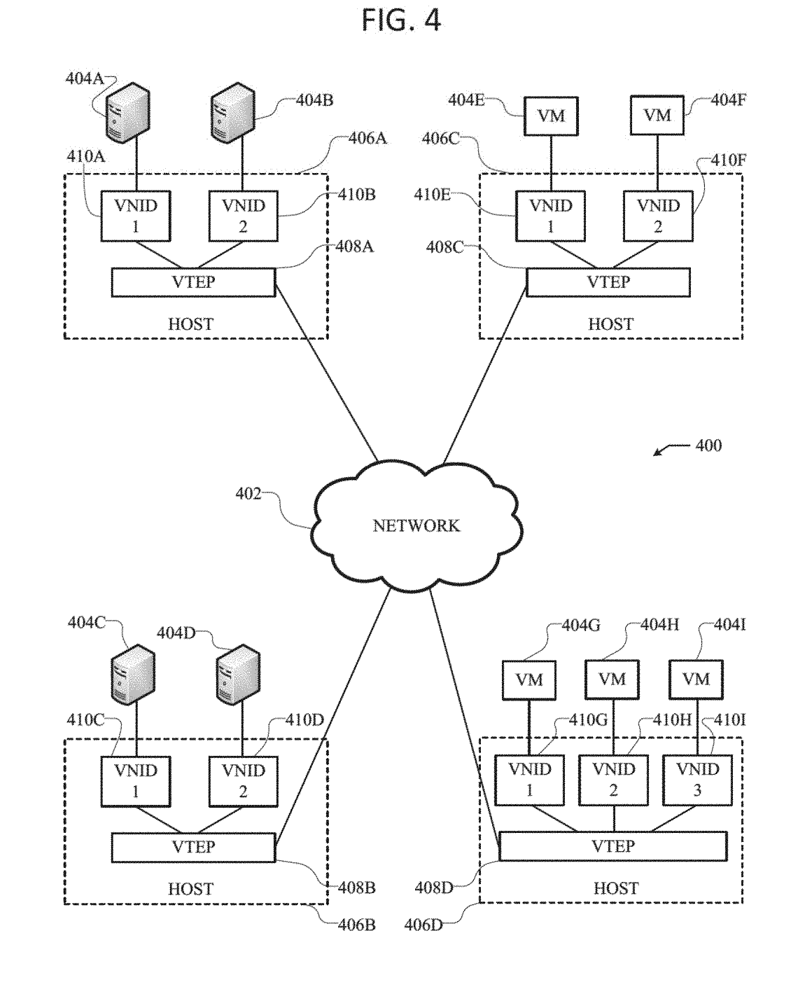

Moreover, the leaf switches 304 can contain virtual switching functionalities, such as a virtual tunnel end point (VTEP) function as explained below in the discussion of VTEP 408 in FIG. 4. To this end, leaf switches 304 can connect the fabric 312 to an overlay network, such as overlay network 400 illustrated in FIG. 4.

Network connectivity in the fabric 312 can flow through the leaf switches 304. Here, the leaf switches 304 can provide servers, resources, end points, external networks, microservice containers or VMs access to the fabric 312, and can connect the leaf switches 304 to each other. In some cases, the leaf switches 304 can connect EPGs to the fabric 312 and/or any external networks. Each EPG can connect to the fabric 312 via one of the leaf switches 304, for example.

End points 310A-E (collectively “310”) can connect to the fabric 312 via leaf switches 304. For example, end points 310A and 310B can connect directly to leaf switch 304A, which can connect end points 310A and 310B to the fabric 312 and/or any other one of the leaf switches 304 Similarly, end point 310E can connect directly to leaf switch 304C, which can connect end point 310E to the fabric 312 and/or any other of the leaf switches 304. On the other hand, end points 310C and 310D can connect to leaf switch 304B via L2 network 306 Similarly, the wide area network (WAN) can connect to the leaf switches 304C or 304D via L3 network 308.

End points 310 can include any communication device, such as a computer, a server, a switch, a router, etc. In some cases, the end points 310 can include a server, hypervisor, or switch configured with a VTEP functionality which connects an overlay network, such as overlay network 400 below, with the fabric 312. For example, in some cases, the end points 310 can represent one or more of the VTEPs 408A-D illustrated in FIG. 4. Here, the VTEPs 408A-D can connect to the fabric 312 via the leaf switches 304. The overlay network can host physical devices, such as servers, applications, EPGs, virtual segments, virtual workloads, etc. In addition, the end points 310 can host virtual workload(s), clusters, and applications or services, which can connect with the fabric 312 or any other device or network, including an external network. For example, one or more end points 310 can host, or connect to, a cluster of load balancers or an EPG of various applications.

Although the fabric 312 is illustrated and described herein as an example leaf-spine architecture, one of ordinary skill in the art will readily recognize that the subject technology can be implemented based on any network fabric, including any data center or cloud network fabric. Indeed, other architectures, designs, infrastructures, and variations are contemplated herein.

FIG. 4 illustrates an exemplary overlay network 400. Overlay network 400 uses an overlay protocol, such as VXLAN, NVGRE, NVO3, or STT, to encapsulate traffic in L2 and/or L3 packets which can cross overlay L3 boundaries in the network. As illustrated in FIG. 4, overlay network 400 can include host nodes 406A-D interconnected via network 402.

Network 402 can include a packet network, such as an IP network, for example. Moreover, network 402 can connect the overlay network 400 with the fabric 312 in FIG. 3. For example, VTEPs 408A-D can connect with the leaf switches 304 in the fabric 312 via network 402.

Hosts 406A-D include virtual tunnel end points (VTEP) 408A-D, which can be virtual nodes or switches configured to encapsulate and de-encapsulate data traffic according to a specific overlay protocol of the network 400, for the various virtual network identifiers (VNIDs) 410A-I. Moreover, hosts 406A-D can include servers containing a VTEP functionality, hypervisors, and physical switches, such as L3 switches, configured with a VTEP functionality. For example, hosts 406A and 406B can be physical switches configured to run VTEPs 408A-B. Here, hosts 406A and 406B can be connected to servers 404A-D, which, in some cases, can include virtual workloads through microservice container or VMs loaded on the servers, for example.

In some embodiments, network 400 can be a VXLAN network, and VTEPs 408A-D can be VXLAN tunnel end points (VTEP). However, as one of ordinary skill in the art will readily recognize, network 400 can represent any type of overlay or software-defined network, such as NVGRE, STT, or even overlay technologies yet to be invented.

The VNIDs can represent the segregated virtual networks in overlay network 400. Each of the overlay tunnels (VTEPs 408A-D) can include one or more VNIDs. For example, VTEP 408A can include VNIDs 1 and 2, VTEP 408B can include VNIDs 1 and 2, VTEP 408C can include VNIDs 1 and 2, and VTEP 408D can include VNIDs 1-3. As one of ordinary skill in the art will readily recognize, any particular VTEP can, in other embodiments, have numerous VNIDs, including more than the 3 VNIDs illustrated in FIG. 4.

The traffic in overlay network 400 can be segregated logically according to specific VNIDs. This way, traffic intended for VNID 1 can be accessed by devices residing in VNID 1, while other devices residing in other VNIDs (e.g., VNIDs 2 and 3) can be prevented from accessing such traffic. In other words, devices or end points connected to specific VNIDs can communicate with other devices or end points connected to the same specific VNIDs, while traffic from separate VNIDs can be isolated to prevent devices or end points in other specific VNIDs from accessing traffic in different VNIDs.

Servers 404A-D and VMs 404E-I can connect to their respective VNID or virtual segment, and communicate with other servers or VMs residing in the same VNID or virtual segment. For example, server 404A can communicate with server 404C and VMs 404E and 404G because they all reside in the same VNID, viz., VNID 1. Similarly, server 404B can communicate with VMs 404F and 404H because they all reside in VNID 2. VMs 404E-I can host virtual workloads, which can include application workloads, resources, and services, for example. However, in some cases, servers 404A-D can similarly host virtual workloads through VMs hosted on the servers 404A-D. Moreover, each of the servers 404A-D and VMs 404E-I can represent a single server or VM, but can also represent multiple servers or VMs, such as a cluster of servers or VMs.

VTEPs 408A-D can encapsulate packets directed at the various VNIDs 1-3 in the overlay network 400 according to the specific overlay protocol implemented, such as VXLAN, so traffic can be properly transmitted to the correct VNID and recipient(s). Moreover, when a switch, router, or other network device receives a packet to be transmitted to a recipient in the overlay network 400, it can analyze a routing table, such as a lookup table, to determine where such packet needs to be transmitted so the traffic reaches the appropriate recipient. For example, if VTEP 408A receives a packet from end point 404B that is intended for end point 404H, VTEP 408A can analyze a routing table that maps the intended end point, end point 404H, to a specific switch that is configured to handle communications intended for end point 404H. VTEP 408A might not initially know, when it receives the packet from end point 404B, that such packet should be transmitted to VTEP 408D in order to reach end point 404H. Accordingly, by analyzing the routing table, VTEP 408A can lookup end point 404H, which is the intended recipient, and determine that the packet should be transmitted to VTEP 408D, as specified in the routing table based on end point-to-switch mappings or bindings, so the packet can be transmitted to, and received by, end point 404H as expected.

However, continuing with the previous example, in many instances, VTEP 408A may analyze the routing table and fail to find any bindings or mappings associated with the intended recipient, e.g., end point 404H. Here, the routing table may not yet have learned routing information regarding end point 404H. In this scenario, the VTEP 408A may likely broadcast or multicast the packet to ensure the proper switch associated with end point 404H can receive the packet and further route it to end point 404H.

In some cases, the routing table can be dynamically and continuously modified by removing unnecessary or stale entries and adding new or necessary entries, in order to maintain the routing table up-to-date, accurate, and efficient, while reducing or limiting the size of the table.

As one of ordinary skill in the art will readily recognize, the examples and technologies provided above are simply for clarity and explanation purposes, and can include many additional concepts and variations.

Depending on the desired implementation in the network 400, a variety of networking and messaging protocols may be used, including but not limited to TCP/IP, open systems interconnection (OSI), file transfer protocol (FTP), universal plug and play (UpnP), network file system (NFS), common internet file system (CIFS), AppleTalk etc. As would be appreciated by those skilled in the art, the network 400 illustrated in FIG. 4 is used for purposes of explanation, a network system may be implemented with many variations, as appropriate, in the configuration of network platform in accordance with various embodiments of the present disclosure.

Having disclosed a brief introductory description of exemplary systems and networks, the discussion now turns to an intuitive approach to visualize health of microservice policies.

Container based microservices allow for an application to be easily scaled. Rather than build a single monstrous, monolithic application, container based microservices split the application into a set of smaller interconnected services. To scale any individual microservice of the application, container instances providing the specified microservice can be newly allocated or removed from the network.

To further manage and monitor each microservice, microservice containers can be assigned to an EPG based on the specified microservice provided by the microservice container. For instance, EPGs can be used to efficiently define policy within a network. By defining Group Based Policies (GBP) according to EPGs rather than policies for individual end points, the scalability of the policy table can be greatly increased. As such, the GBP can describe a range of each traffic classifier between EPGs.

A set of policies can be applied to an EPG to achieve a desired performance or intent for the microservice containers included in the EPG. For example, if the desired performance or intent for the microservice is that latency not exceed a specified threshold latency, a set of policies can be applied to the EPG to proactively allocate new container instances providing the microservice in response to a determination that the threshold latency has been met or exceeded.

In this way, the set of policies can designate a desired performance level of an EPG as well as remedial actions to be taken if the EPG is not performing at the desired performance level. To provide greater customization and control of an application and the individual microservices, the set of policies assigned to each end point group can be unique to that EPG to provide a desired performance level based on the micro service containers included in the EPG.

To ensure that the desired policies are being applied and performing correctly, the network can be configured to monitor performance of an EPG to determine whether the EPG is performing at the desired performance level. For example, the network can include a controller configured to gather operational data describing performance of an EPG in the network. The controller can use the operational data to calculate an overall health score for the EPG that indicates whether an actual overall performance of the EPG is meeting a desired overall performance of the EPG defined by a set of policies assigned to the end point group. The controller can then present a visual representation of the overall health score in a graphical user interface. The visual representation of the overall health score can indicate an overall health range that the overall health score falls within. This intuitive approach to visualizing health of microservice policies can allow an administrator to easily determine how desired policies are performing and adjust the policies if necessary.

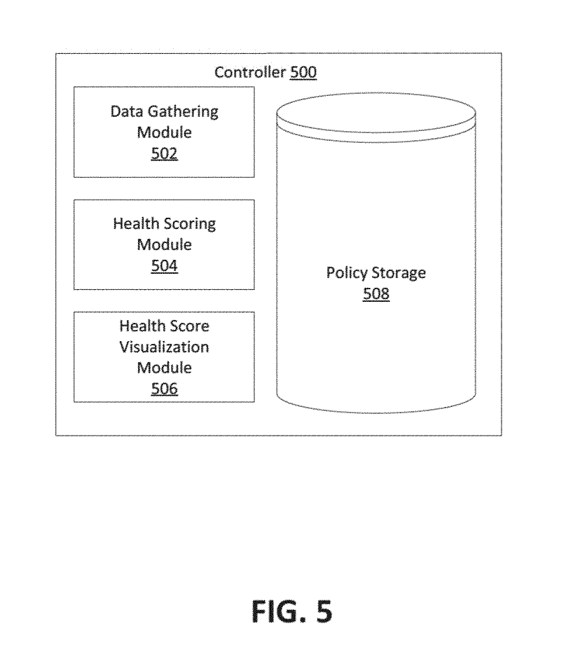

FIG. 5 illustrates an example controller for visualizing health of microservice policies. Controller 500 can be any type of device in a network, such as a computing device, switch, end point, etc. As shown, controller 500 can include data gathering module 502 that is configured to gather operational data from the network. Operational data can be any type of data that describes the performance of individual end points (e.g., microservice containers) and/or an EPG (e.g., group of microservice containers), including the network. For example, operational data can include current load, errors, warnings, exceptions, central processing unit (CPU) rate, disks, memory, server node state, etc. Operational data can also including networking data such as bandwidth, throughput, delay, latency, jitter, total packets dropped, packet drop rate, error rate, Tx and Rx counters, port queue length, tail drops, network node state, etc.

Controller 500 can further include health scoring module 504 configured to calculate health scores for EPGs based on the gathered operational data. A health score can indicate whether an actual performance of an EPG is meeting a desired performance of the EPG defined by a set of policies assigned to the EPG. Health scoring module 504 can calculate an overall health score for an EPG or, alternatively, individual health scores for individual policies assigned to an EPG. An overall health score can indicate whether the overall performance of the EPG is meeting the desired performance dictated by the set of policies as a whole. Alternatively, an individual health score can indicate whether performance of the EPG is meeting a desired individual performance dictated by an individual policy assigned to the EPG. Controller 500 can include policy storage 508 configured to store set of policies for one or more EPGs.

Health scoring module 504 can be calculate health scores in any of a number of ways and based on any number of factors. In some embodiments, health scoring module 504 can calculate individual scores for multiple factors and calculate the health score based on the individual scores. For example, health scoring module 504 can add the individual scores together to calculate the health score. As another example, health scoring module 504 can determine the mean of the individual scores to calculate the health score for the EPG.

In some embodiments, health scoring module 504 can apply varying weights to the individual scores when calculating the health score. For example, individual scores for factors considered to be of greater importance can be assigned a higher weight and therefor have greater influence on the health score. Conversely, individual scores for factors considered to be of lower importance can be assigned a lower weight and have a lesser impact on the health score.

In additional to calculating overall or individual health scores for an EPG, health scoring module 504 can further categorize health scores into health score ranges that indicating the relative performance of the EPG or individual policy. For example, a health score range can indicate that a health score is good, fair or bad. Health scoring module 504 can categorize a health score based on predetermined health score range limits. For example, assuming a total health score range from 1-90, a first health score range between 1-30 can indicate that the health is poor, a second health score range between 30-60 can indicate that health is fair, and a third health score range between 60-90 can indicate that health is good.

Controller 500 can further include health score visualization module 506 configured to present a visual representation of a health score. For example, health score visualization module 506 can present a visual representation of an overall health score for an EPG in a graphical user interface. The visual representation of the overall health score can indicate the overall health score and/or the categorization of the overall health score into an overall health score range. Health score visualization module 506 can further present a visual representation of one or more individual health scores indicating individual health scores and/or categorizations of the individual health scores into an individual health score range.

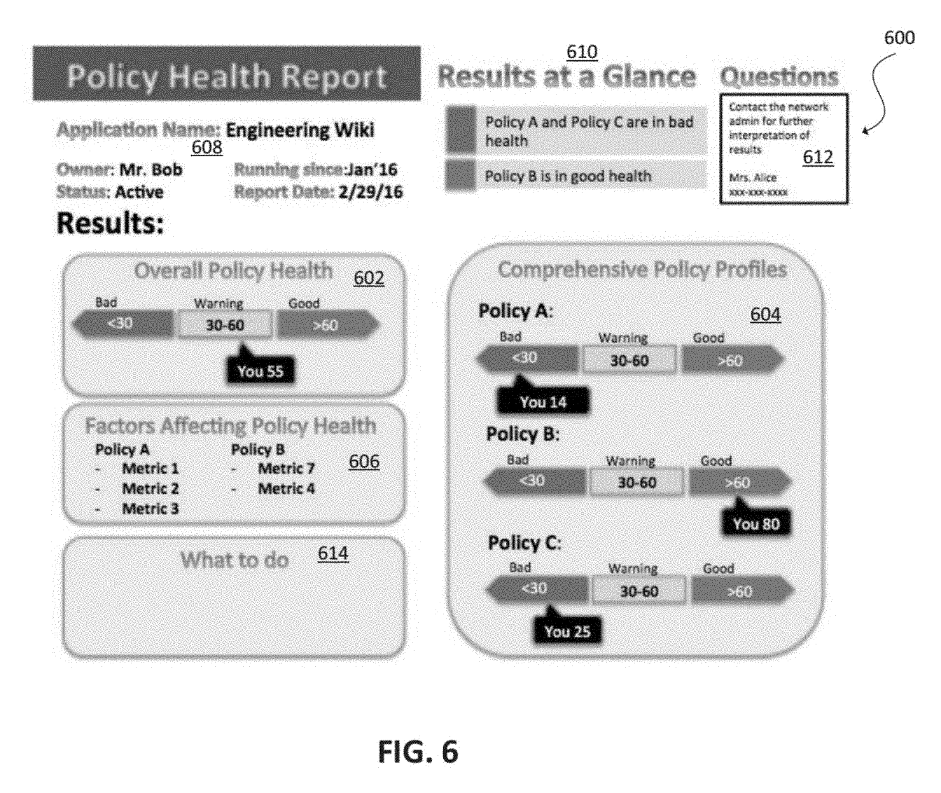

FIG. 6 shows an example embodiment of a graphical user interface presenting a visual representation of a health score. As shown, graphical user interface 600 includes visual representation 602 that presents an overall health score for an EPG. As shown, visual representation 602 presents the exact overall health score (i.e., 55) as well as a categorization of the overall health score into an overall health score range (i.e., warning). Visual representation 602 includes a bar graph indicating each overall health score range (i.e., bad, warning and good), as well as the positioning of the overall health score along the bar graph. This can allow an administrator to easily gauge the overall health of the EPG.

Graphical user interface 600 also includes visual representation 604 that presents three individual health scores, each representing health of an individual policy (i.e., policy A, policy B, and policy C). Similar to visual representation 602, visual representation 604 includes a bar graph for each individual health score that presents each individual health score range as well as the position of the individual health score along the bar graph. An administrator can easily discern from visual representation 604 that policy A and policy C are in poor health, while policy B is in good health. Accordingly, an administrator can identify the specific policies that need to be adjusted to increase overall performance and health of the EPG. While horizontal bar graphs are shown in FIG. 6, this is only one example and is not meant to be limiting. Any type of graph or chart can be used to present data in graphical user interface 600, such as vertical bar graphs, horizontal bar graphs, pie charts, etc.

In addition to presenting health scores, graphical user interface 600 can also present additional information that can assist an administrator with managing an EPG. As shown, graphical user interface 600 includes visual representation 606 that identifies the specific metrics utilized to calculate the individual health scores. As shown, metrics 1, 2 and 3 were used to calculate the individual health score for policy A, and metrics 7 and 4 were used to calculate the individual health score for policy B. An administrator can use the data presented in visual representation 606 to discern the exact metrics that may be causing issues with a given policy.

Visual representation 608 provides general information about the EPG. For example, visual representation 608 provides the name of the application, the owner of the application, the status of the application (i.e., active), how long the application has been running as well as the report date of graphical user interface 600.

Visual representation 610 provides a quick summary of the data presented in graphical user interface 600. As shown, visual representation 610 summarizes that policy A and policy C are each in bad health, while policy B is in good health.

Visual representation 612 provides contact information that a user can use for additional information. As shown, visual representation 612 identifies Mrs. Alice as being an administrator to contact for further interpretation of the results presented in graphical user interface 600.

Visual representation 614 can present one or more suggested remedial steps or actions that can be taken by an administrator to alleviate issues with one or more of the policies.

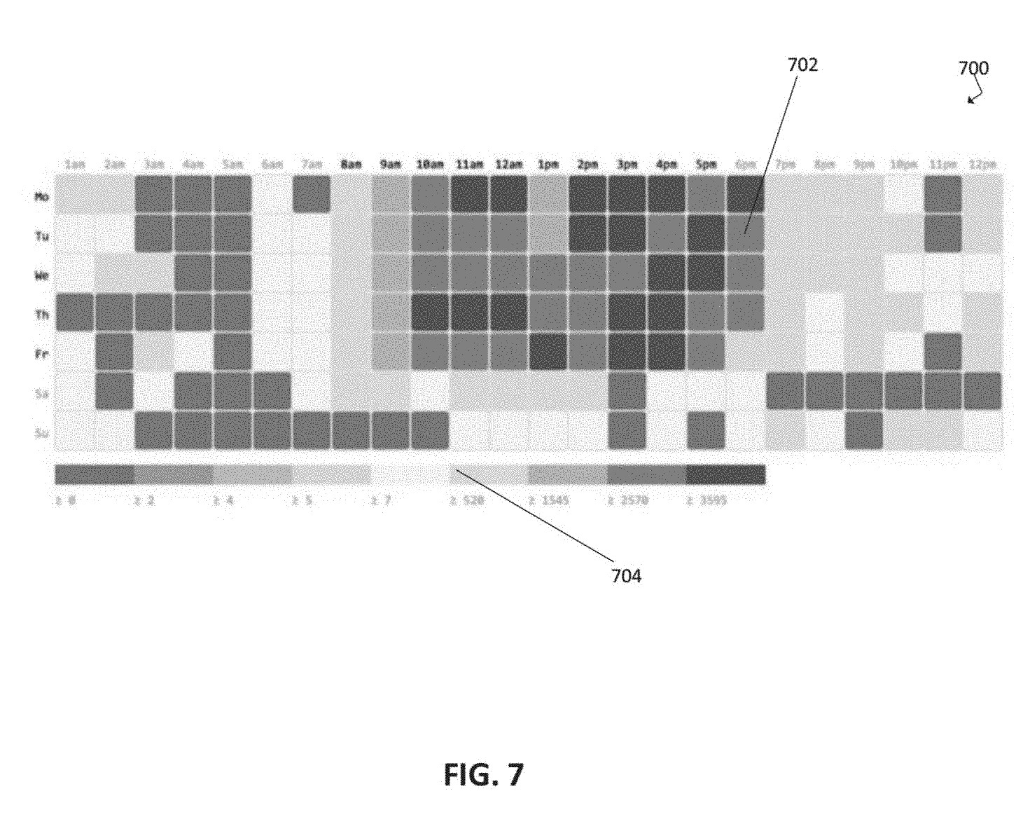

FIG. 7 illustrates another example embodiment of a graphical user interface presenting a visual representation of a health score. As shown, graphical user interface 700 includes heat map 702 that presents graphical representations of health scores calculated hourly over a span of 7 days. Rather than present the specific health score at each time, heat map 702 includes color coded squares that indicate the health score range of the health score at each time interval (i.e., each hour). For example, a red square can indicate that the health score is categorized as being in bad health, a yellow square can indicate that the health score is categorized as being in fair health, and a red square can indicate that the health score is categorized as being in good health. Additionally, graphical user interface 700 can include score index 704 that identifies the health score ranges corresponding to each color used for the color coded squares in heat map 702. A system administrator can use heat map 702 and score index 704 to easily view health trends hourly over the span of the seven days.

While heat map 702 does not include the exact health score at each time interval, this is only one example and is not meant to be limiting. In some embodiments, the individual scores can be presented within the color coded squares for each time interval. Further, heat map 702 can be used to present either an overall health score or individual health score.

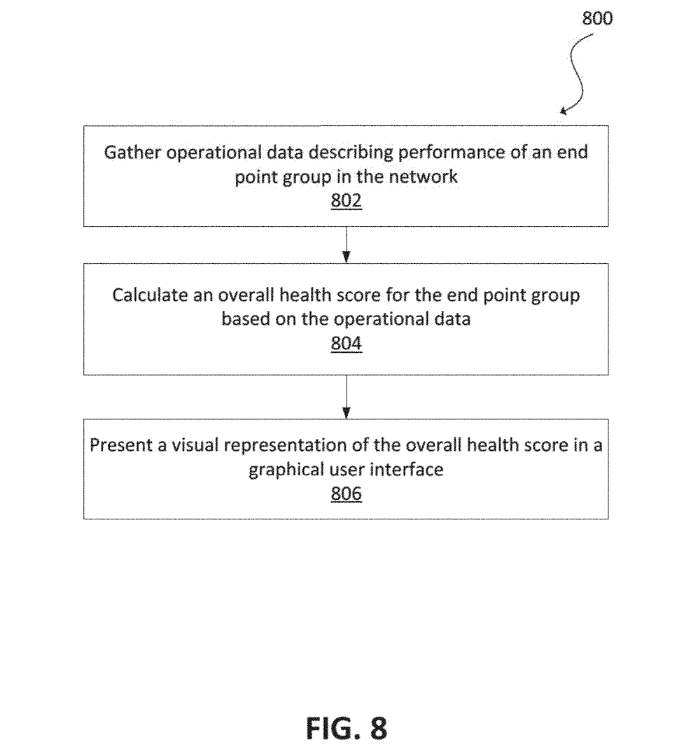

FIG. 8 illustrates an example method 800 of visualizing health of microservice policies. It should be understood that there can be additional, fewer, or alternative steps performed in similar or alternative orders, or in parallel, within the scope of the various embodiments unless otherwise stated.

At step 802, a controller in a network can gather operational data describing performance of an end point group in the network. The end point group can include one or more containers providing micro services. The operational data can include at least one of bandwidth, throughput, delay, latency, jitter, total packets dropped, packet drop rate, error rate, Tx and Rx counters, port queue length, tail drops, connections served, connections rejected, rate of connections, and network node state.

At step 804, the controller can calculate an overall health score for the end point group based on the operational data. The overall health score can indicate whether an actual overall performance of the end point group is meeting a desired overall performance of the end point group defined by a first set of policies assigned to the end point group.

At step 806, the controller can present a visual representation of the overall health score in a graphical user interface. The visual representation of the overall health score can indicate that the first overall health score is within a first overall health range from a set of two or more overall health ranges. For example, the visual representation of the overall health score can include a first bar graph indicating each overall health range from the set of two or more overall health ranges and a visual representation of the overall health score on the first bar graph.

As another example, presenting the visual representation of the overall health score can include displaying a color coded representation of the overall health score in a heat map. The heat map can include multiple color coded representations of overall health scores determined at various times and the color coded representations of each overall health score in the heat map can indicate which overall health range from the set of two or more overall health ranges that each overall health score is within. Additionally, the controller can present a visual listing or one or more metrics utilized to calculate the overall health score.

As one of ordinary skill in the art will readily recognize, the examples and technologies provided above are simply for clarity and explanation purposes, and can include many additional concepts and variations.

For clarity of explanation, in some instances the present technology may be presented as including individual functional blocks including functional blocks comprising devices, device components, steps or routines in a method embodied in software, or combinations of hardware and software.

In some embodiments the computer-readable storage devices, mediums, and memories can include a cable or wireless signal containing a bit stream and the like. However, when mentioned, non-transitory computer-readable storage media expressly exclude media such as energy, carrier signals, electromagnetic waves, and signals per se.

Methods according to the above-described examples can be implemented using computer-executable instructions that are stored or otherwise available from computer readable media. Such instructions can comprise, for example, instructions and data which cause or otherwise configure a general purpose computer, special purpose computer, or special purpose processing device to perform a certain function or group of functions. Portions of computer resources used can be accessible over a network. The computer executable instructions may be, for example, binaries, intermediate format instructions such as assembly language, firmware, or source code. Examples of computer-readable media that may be used to store instructions, information used, and/or information created during methods according to described examples include magnetic or optical disks, flash memory, USB devices provided with non-volatile memory, networked storage devices, and so on.

Devices implementing methods according to these disclosures can comprise hardware, firmware and/or software, and can take any of a variety of form factors. Typical examples of such form factors include laptops, smart phones, small form factor personal computers, personal digital assistants, rackmount devices, standalone devices, and so on. Functionality described herein also can be embodied in peripherals or add-in cards. Such functionality can also be implemented on a circuit board among different chips or different processes executing in a single device, by way of further example.

The instructions, media for conveying such instructions, computing resources for executing them, and other structures for supporting such computing resources are means for providing the functions described in these disclosures.

Although a variety of examples and other information was used to explain aspects within the scope of the appended claims, no limitation of the claims should be implied based on particular features or arrangements in such examples, as one of ordinary skill would be able to use these examples to derive a wide variety of implementations. Further and although some subject matter may have been described in language specific to examples of structural features and/or method steps, it is to be understood that the subject matter defined in the appended claims is not necessarily limited to these described features or acts. For example, such functionality can be distributed differently or performed in components other than those identified herein. Rather, the described features and steps are disclosed as examples of components of systems and methods within the scope of the appended claims. Moreover, claim language reciting “at least one of” a set indicates that one member of the set or multiple members of the set satisfy the claim.

Note that in certain example implementations, the optimization and/or placement functions outlined herein may be implemented by logic encoded in one or more tangible, non-transitory media (e.g., embedded logic provided in an application specific integrated circuit [ASIC], digital signal processor [DSP] instructions, software [potentially inclusive of object code and source code] to be executed by a processor, or other similar machine, etc.). The computer-readable storage devices, mediums, and memories can include a cable or wireless signal containing a bit stream and the like. However, when mentioned, non-transitory computer-readable storage media expressly exclude media such as energy, carrier signals, electromagnetic waves, and signals per se.

Methods according to the above-described examples can be implemented using computer-executable instructions that are stored or otherwise available from computer readable media. Such instructions can comprise, for example, instructions and data which cause or otherwise configure a general purpose computer, special purpose computer, or special purpose processing device to perform a certain function or group of functions. Portions of computer resources used can be accessible over a network. The computer executable instructions may be, for example, binaries, intermediate format instructions such as assembly language, firmware, or source code. Examples of computer-readable media that may be used to store instructions, information used, and/or information created during methods according to described examples include magnetic or optical disks, flash memory, USB devices provided with non-volatile memory, networked storage devices, and so on.

Devices implementing methods according to these disclosures can comprise hardware, firmware and/or software, and can take any of a variety of form factors. Typical examples of such form factors include laptops, smart phones, small form factor personal computers, personal digital assistants, and so on. Functionality described herein also can be embodied in peripherals or add-in cards. Such functionality can also be implemented on a circuit board among different chips or different processes executing in a single device, by way of further example.

The instructions, media for conveying such instructions, computing resources for executing them, and other structures for supporting such computing resources are means for providing the functions described in these disclosures.

Although a variety of examples and other information was used to explain aspects within the scope of the appended claims, no limitation of the claims should be implied based on particular features or arrangements in such examples, as one of ordinary skill would be able to use these examples to derive a wide variety of implementations. Further and although some subject matter may have been described in language specific to examples of structural features and/or method steps, it is to be understood that the subject matter defined in the appended claims is not necessarily limited to these described features or acts. For example, such functionality can be distributed differently or performed in components other than those identified herein. Rather, the described features and steps are disclosed as examples of components of systems and methods within the scope of the appended claims.

1. A method comprising:
gathering, by a controller in a network, operational data describing performance of an end point group in the network, wherein the end point group includes one or more containers providing micro services;
calculating an overall health score for the end point group based on the operational data, the overall health score indicating whether an actual overall performance of the end point group is meeting a desired overall performance of the end point group defined by a first set of policies assigned to the end point group; and
presenting, in a graphical user interface, a visual representation of the overall health score, the visual representation of the overall health score indicating that the overall health score is within a first overall health range from a set of two or more overall health ranges.

2. The method of claim 1, wherein the visual representation of the overall health score includes a first bar graph indicating each overall health range from the set of two or more overall health ranges and a visual representation of the overall health score on the first bar graph.

3. The method of claim 1, further comprising:
calculating a first individual health score for a first policy from the first set of policies assigned to the end point group, the first individual health score indicating whether an actual individual performance of the end point group is meeting a desired individual performance of the end point group defined by the first policy; and
presenting, in the graphical user interface, a visual representation of the first individual health score, the visual representation of the first individual health score indicating that the first individual health score is within a first individual health range from a set of two or more individual health ranges.

4. The method of claim 3, wherein the visual representation of the first individual health score includes a second bar graph indicating each individual health range from the set of two or more individual health ranges and a visual representation of the overall health score on the second bar graph.

5. The method of claim 1, wherein the operational data includes at least one of bandwidth, throughput, delay, latency, jitter, total packets dropped, packet drop rate, error rate, Tx and Rx counters, port queue length, tail drops, connections served, connections rejected, rate of connections, and network node state.

6. The method of claim 1, wherein presenting the visual representation of the overall health score comprises:
displaying a color coded representation of the overall health score in a heat map, the heat map including multiple color coded representations of overall health scores determined at various times, wherein the color coded representations of each overall health score in the heat map indicate which overall health range from the set of two or more overall health ranges that each overall health score is within.

7. The method of claim 1, further comprising:
presenting a visual listing or one or more metrics utilized to calculate the overall health score.

8. A controller in a network comprising:
one or more computer processors; and
memory storing instructions that, when executed by the one or more computer processors, cause the controller to:
gather operational data describing performance of an end point group in the network, wherein the end point group includes one or more containers providing micro services;
calculate an overall health score for the end point group based on the operational data, the overall health score indicating whether an actual overall performance of the end point group is meeting a desired overall performance of the end point group defined by a first set of policies assigned to the end point group; and
present, in a graphical user interface, a visual representation of the overall health score, the visual representation of the overall health score indicating that the overall health score is within a first overall health range from a set of two or more overall health ranges.

9. The controller of claim 8, wherein the visual representation of the overall health score includes a first bar graph indicating each overall health range from the set of two or more overall health ranges and a visual representation of the overall health score on the first bar graph.

10. The controller of claim 8, wherein the instructions further cause the controller to:
calculate a first individual health score for a first policy from the first set of policies assigned to the end point group, the first individual health score indicating whether an actual individual performance of the end point group is meeting a desired individual performance of the end point group defined by the first policy; and
present, in the graphical user interface, a visual representation of the first individual health score, the visual representation of the first individual health score indicating that the first individual health score is within a first individual health range from a set of two or more individual health ranges.

11. The controller of claim 10, wherein the visual representation of the first individual health score includes a second bar graph indicating each individual health range from the set of two or more individual health ranges and a visual representation of the overall health score on the second bar graph.

12. The controller of claim 8, wherein the operational data includes at least one of bandwidth, throughput, delay, latency, jitter, total packets dropped, packet drop rate, error rate, Tx and Rx counters, port queue length, tail drops, connections served, connections rejected, rate of connections, and network node state.

13. The controller of claim 8, wherein presenting the visual representation of the overall health score comprises:
displaying a color coded representation of the overall health score in a heat map, the heat map including multiple color coded representations of overall health scores determined at various times, wherein the color coded representations of each overall health score in the heat map indicate which overall health range from the set of two or more overall health ranges that each overall health score is within.

14. The controller of claim 8, wherein the instructions further cause the controller to:
present a visual listing or one or more metrics utilized to calculate the overall health score.

15. A non-transitory computer-readable medium storing instructions that, when executed by a controller in a network, cause the controller to:
gather operational data describing performance of an end point group in the network, wherein the end point group includes one or more containers providing micro services;
calculate an overall health score for the end point group based on the operational data, the overall health score indicating whether an actual overall performance of the end point group is meeting a desired overall performance of the end point group defined by a first set of policies assigned to the end point group; and
present, in a graphical user interface, a visual representation of the overall health score, the visual representation of the overall health score indicating that the overall health score is within a first overall health range from a set of two or more overall health ranges.

16. The non-transitory computer-readable medium of claim 15, wherein the visual representation of the overall health score includes a first bar graph indicating each overall health range from the set of two or more overall health ranges and a visual representation of the overall health score on the first bar graph.

17. The non-transitory computer-readable medium of claim 15, wherein the instructions further cause the controller to:
calculate a first individual health score for a first policy from the first set of policies assigned to the end point group, the first individual health score indicating whether an actual individual performance of the end point group is meeting a desired individual performance of the end point group defined by the first policy; and
present, in the graphical user interface, a visual representation of the first individual health score, the visual representation of the first individual health score indicating that the first individual health score is within a first individual health range from a set of two or more individual health ranges.

18. The non-transitory computer-readable medium of claim 17, wherein the visual representation of the first individual health score includes a second bar graph indicating each individual health range from the set of two or more individual health ranges and a visual representation of the overall health score on the second bar graph.

19. The non-transitory computer-readable medium of claim 15, wherein the operational data includes at least one of bandwidth, throughput, delay, latency, jitter, total packets dropped, packet drop rate, error rate, Tx and Rx counters, port queue length, tail drops, connections served, connections rejected, rate of connections, and network node state.

20. The non-transitory computer-readable medium of claim 15, wherein presenting the visual representation of the overall health score comprises:
displaying a color coded representation of the overall health score in a heat map, the heat map including multiple color coded representations of overall health scores determined at various times, wherein the color coded representations of each overall health score in the heat map indicate which overall health range from the set of two or more overall health ranges that each overall health score is within.
